(19) United States
(12) Patent Application Publication
(10) Pub. No.: US 2018/0048914 A1
(43) Pub. Date: Feb. 15, 2018

(54) Image processing method and related apparatus

(71) Applicant: NOVATEK Microelectronics Corp., Hsin-Chu (TW)

(72) Inventors: Sheng-Tien Cho, Hsinchu City (TW); Ching-Pei Cheng, Hsinchu City (TW); Hsueh-Yen Yang, Taoyuan City (TW)

(21) Appl. No.: 15/673,432

(22) Filed: Aug. 10, 2017

Related U.S. Application Data
(60) Provisional application No. 62/373,979, filed on Aug. 11, 2016.

(51) Int. Cl. H04N 19/60; H04N 19/44; H04N 5/232; H04N 19/182

(52) U.S. Cl. CPC H04N 19/60; H04N 19/182; H04N 19/44; H04N 5/23293

(57) ABSTRACT

An image processing method includes performing subpixel rendering operation on a first image data to generate a second image data; and encoding the second image data to generate a third image data which has a size smaller than a size of the second image data.

### CROSS REFERENCE TO RELATED APPLICATIONS

This application claims the benefit of U.S. Provisional Application No. 62/373,979, filed on Aug. 11, 2016, the contents of which are incorporated herein by reference.

### BACKGROUND OF THE INVENTION

### 1. Field of the Invention

The present invention relates to an image processing method and an image processing apparatus, and more particularly, to an image processing method and an image processing apparatus capable of performing subpixel rendering (SPR).

### 2. Description of the Prior Art

Along with the ever-increasing growth of display related technologies, demand for high resolution display devices rises dramatically in recent years. As the image resolution increases, a display driver integrated circuit (IC) of a high resolution display device requires extra power and more time to process image data of high resolution to drive the increasing number of pixels. Subpixel rendering (SPR) technique is developed for displaying image data of high resolution on a display panel with a specific subpixel arrangement. In SPR operation, input image data for full-color pixels each having red, green, and blue (abbreviated to R, G, and B) subpixels is converted to output image data for pixels under the specific subpixel arrangement, for example each having two of the RGB subpixels, wherein another color component is rendered (or borrowed) from a neighbor pixel. In an example, when subpixels are repeatedly arranged by RG and BG in every display line, a pixel having RG subpixels displays image data by borrowing the blue subpixel from a neighbor pixel having BG subpixels. In another example, when subpixels are repeatedly arranged by RG, BR and GB in every display line, a pixel having BR subpixels displays image data by borrowing the green subpixel from one of neighbor pixels having RG subpixels or having GB subpixels.

FIG. 1 is a schematic diagram of a conventional image processing unit 10 in a display driver IC. The image processing unit 10 receives image data D1a from an image input unit 100. The image input unit 100 may be an application processor, but not limited thereto. The image data D1a is frame data, e.g., 8-bit RGB data of 1080×1920 pixels, where 1080×1920 is frame resolution (or called image resolution). The image processing unit 10 comprises a compression encoder 102, a frame buffer 104, a compression decoder 106, an image enhancement unit 108 and a subpixel rendering unit 110. To reduce size of the frame buffer 104 used in the display driver IC, the compression encoder 102 is therefore utilized to shrink the size of image data D1a that needs to be further processed or transmitted. For example, the compression encoder 102 encodes the image data D1a of N×M pixels, which has a data size K bits, to generate image data D2a which is ⅓ size of the image data D1a, ⅓× K bits, based on the assumption of a data compression ratio (uncompressed size/compressed size) 3:1 of the compression encoder 102. After the image data D1a sent from the image input unit 100 is encoded to the image data D2a, the compression encoder 102 delivers the image data D2a to the frame buffer 104. For example, if the image data D1a is 8-bit RGB data and has a frame resolution 1080×1920 pixels, the K bits of the image data D1a is 1080×1920×3×8=49,766,400 bits.

The size of the frame buffer 104 shall be at least enough to accommodate the image data D2a generated by the compression encoder 102. The frame buffer 104 stores the image data D2a received from the compression encoder 102. The compression decoder 106 accesses the frame buffer 104 to receive the image data D2a, and decodes the image data D2a to generate image data D3a, which is of the same size as the image data D1a. The compression decoder 106 transmits the image data D3a to the image enhancement unit 108. The image data D3a is further processed by the image enhancement unit 108 to make image manipulations and improvements on the image data D3a, such as sharpness, and image data D4a is generated without affecting its size. Finally, the subpixel rendering unit 110 performs subpixel rendering operation on the image data D4a, which is to convert the image data D4a of K bits transmitted from the image enhancement unit 108 into image data D5a of ⅔×K bits to be displayed in a display panel 112 of specific subpixel arrangement. The data size of image data D5a is associated with the subpixel arrangement of the display panel 112.

The frame buffer size is an important design issue since the cost of the frame buffer occupies a large proportion in the cost of a display driver IC. In the image processing unit 10, the size of the frame buffer 104 can be reduced by using a proper compression ratio (uncompressed size/compressed size) of the compression encoder 102. When the image resolution increases and the size of input image data (from the image input unit 100) increases, it is not a good solution to use a larger compression ratio to achieve the frame buffer reduction because the higher the compression ratio of the compression encoder 102, the more complexity the compression encoder 102 would have.

### SUMMARY OF THE INVENTION

It is therefore an objective of the present invention to provide an image processing method and an image processing apparatus, which are capable of performing subpixel rendering.

An embodiment of the present invention discloses an image processing method. The image processing method comprises performing subpixel rendering operation on a first image data to generate a second image data; and encoding the second image data to generate a third image data which has a size smaller than a size of the second image data.

An embodiment of the present invention further discloses an image processing apparatus configured to render image displayed on a display. The image processing apparatus comprises a subpixel rendering unit and a compression encoder. The subpixel rendering unit is configured to perform subpixel rendering operation on a first image data to generate a second image data. The compression encoder is configured to encode the second image data into a third image data which has a size smaller than a size of the second image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional image processing unit in a display driver IC.

FIG. 2 is a schematic diagram of an image processing unit according to an embodiment of the present invention.

FIG. 3 is a schematic diagram of pixels of a full-color display panel of RGB stripe type.

FIG. 4 is a schematic diagram of pixels of the display panel of an exemplary subpixel arrangement according to an example of the present disclosure.

FIG. 5 is a schematic diagram of image data of a frame as the image data received by the subpixel rendering unit.

FIG. 6 is a schematic diagram of image data of a frame as the image data generated by the subpixel rendering unit and configured to be displayed on a display panel having N×M pixels with RGBG subpixel arrangement as shown in FIG. 4.

FIG. 7 is a schematic diagram of an image processing unit according to an embodiment of the present invention.

FIG. 8 is a schematic diagram of an image processing unit according to an embodiment of the present invention.

FIG. 9 is a schematic diagram of an image processing process according to an embodiment of the present invention.

### DETAILED DESCRIPTION

A novel structure of an image processing unit is proposed and several embodiments are introduced in the following.

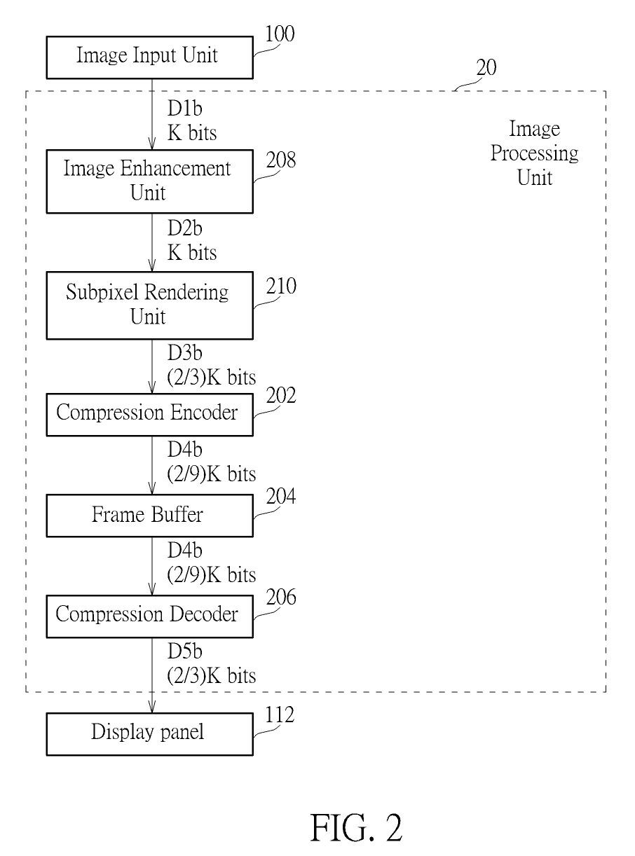

Please refer to FIG. 2, which is a schematic diagram of an image processing unit 20 according to an embodiment of the present invention. The image processing unit 20 is installed in an image processing apparatus. The image processing unit 20 receives image data D1b from the image input unit 100. The image processing unit 20 also comprises a compression encoder 202, a frame buffer 204, a compression decoder 206, an image enhancement unit 208 and a subpixel rendering unit 210. The image processing apparatus where the image processing unit 20 is installed may be a display driver IC used in a mobile device or a handheld device (such as mobile phone, tablet, camera, etc.) or a timing controller used in a TV or a monitor. The image input unit 100 may be an application processor if the image processing unit 20 is installed in a display driver IC for a mobile device. Or, the image input unit 100 may be a TV controller if the image processing unit 20 is installed in a timing controller for a TV. Or, the image input unit 100 may be a graphic controller if the image processing unit 20 is installed in a timing controller for a monitor (with a desktop computer, for example). FIG. 2 may illustrate a block diagram, wherein each block indicates a circuit or a component with respect to corresponding function. FIG. 2 may also be understood as a flow diagram, wherein each block indicates a step of a process.

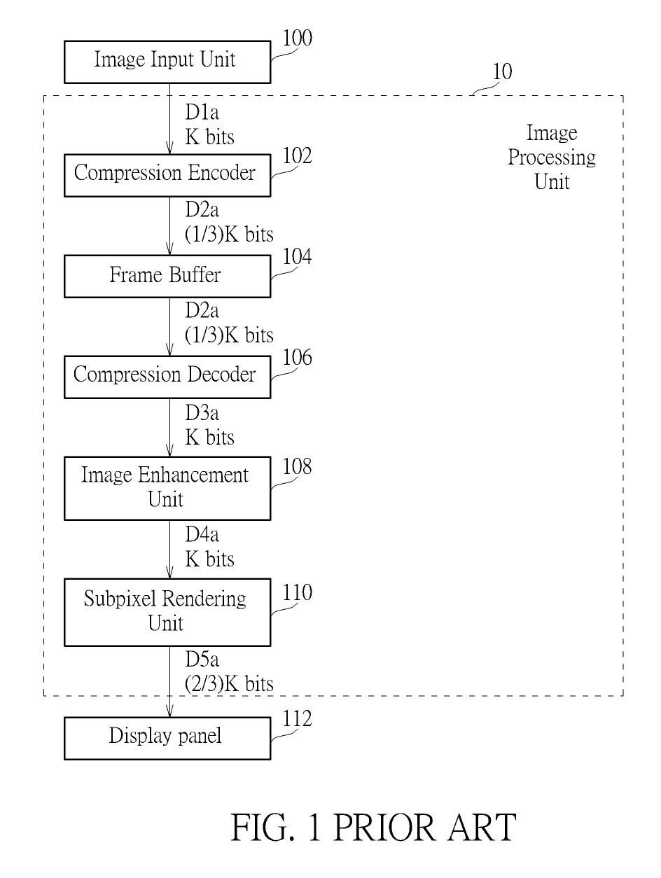

Different from the image processing unit 10 shown in FIG. 1, the image input unit 100 in FIG. 2 sends original image data D1b to the image enhancement unit 208, instead of sending the image data D1b to the compression encoder 202. The image data D1b may have frame resolution N×M pixels and have a data size K bits. The image enhancement unit 208 performs image enhancement on the image data D1b without affecting its size and generates image data D2b. The image enhancement may be related to sharpness (or contrast), saturation, brightness, or any other characteristics related to the image data D1b. In other words, the image enhancement unit 208 converts or transforms the image data D1b into the image data D2b. Subsequently, the subpixel rendering unit 210 performs subpixel rendering operation on the image data D2b transmitted from the image enhancement unit 208 to generate image data D3b. In the example of FIG. 2, the image data D3b has a data size ⅔×K bits. The size of the image data D3b is determined based on the subpixel arrangement of the display panel 112. It is noted that the image data D3b being of ⅔ size of the image data D2b is one of examples, based on the subpixel arrangement wherein each pixel includes two subpixels (such as RG, BG). For other subpixel arrangement wherein each pixel includes 1.5 or 2.5 subpixels in average, the subpixel rendering unit 210 may use different algorithms to generate the image data D3b of different size. The compression encoder 202 is then utilized for encoding the image data D3b to reduce the size of the image data. By the encoding process, the image data D3b is encoded into image data D4b which has a data size 2/9×K bits, based on an exemplary data compression ratio 3:1 of the compression encoder 202. The data compression ratio of the compression encoder 202 may be different from 3:1 and is not limited to any specific ratio. After the image data D4b is generated, the compression encoder 202 delivers the image data D4b to the frame buffer 204.

The size of the frame buffer 204 shall be at least enough to accommodate the image data outputted from the compression encoder 202. The frame buffer 204 stores the image data D4b received from the compression encoder 202. The compression decoder 206 accesses the frame buffer 204 to obtain the image data D4b and then decodes the image data D4b to generate image data D5b having a data size ⅔×K bits, which is the same size as the image data D3b generated by the subpixel rendering unit 210. The compression decoder 206 provides the image data D5b for generating data voltages to drive pixels of the display panel 112. Note that the image data D5b is digital data, and a driving circuit (not shown) is utilized for converting the image data D5b to analog data voltages to drive pixels, which is well known to those skilled in the art and is omitted herein.

Compared to the conventional image processing unit 10 of FIG. 1, when the compression ratio of the compression encoder 202 is the same as the compression ratio of the compression encoder 102, such as 3×compression (i.e., compression ratio 3:1) as examples illustrated in FIGS. 1 and 2, the image processing unit 20 may include the frame buffer 204 having a size accommodating 2/9×K bits at least, smaller than the frame buffer 104 which has a size accommodating ⅓×K bits at least. This frame buffer reduction is achieved by performing subpixel rendering operation (by the subpixel rendering unit 210) earlier than performing the encoding process (by the compression encoder 202). Therefore, the physical size and cost of the image processing apparatus which uses the image processing unit 20 may be reduced.

In the image processing unit 10, the image data D4a generated by the image enhancement unit 108 may have distortion since the input image data D3a is not an original image from the image input unit 100 but a decoded image data from the compression decoder 106. In comparison, in the image processing unit 20, the image enhancement unit 208 performs image enhancement on the image data D1b, which has not undergone encoding and decoding processes, so that the image data D2b generated by the image enhancement unit 208 may have a better quality than the image data D4a generated by the image enhancement unit 108.

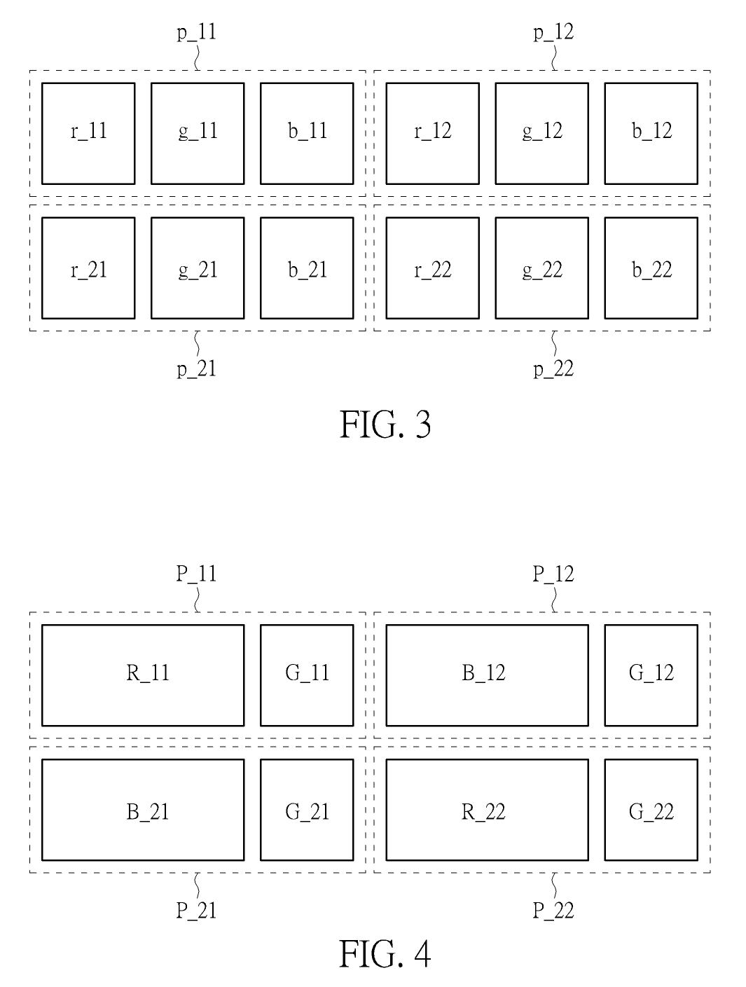

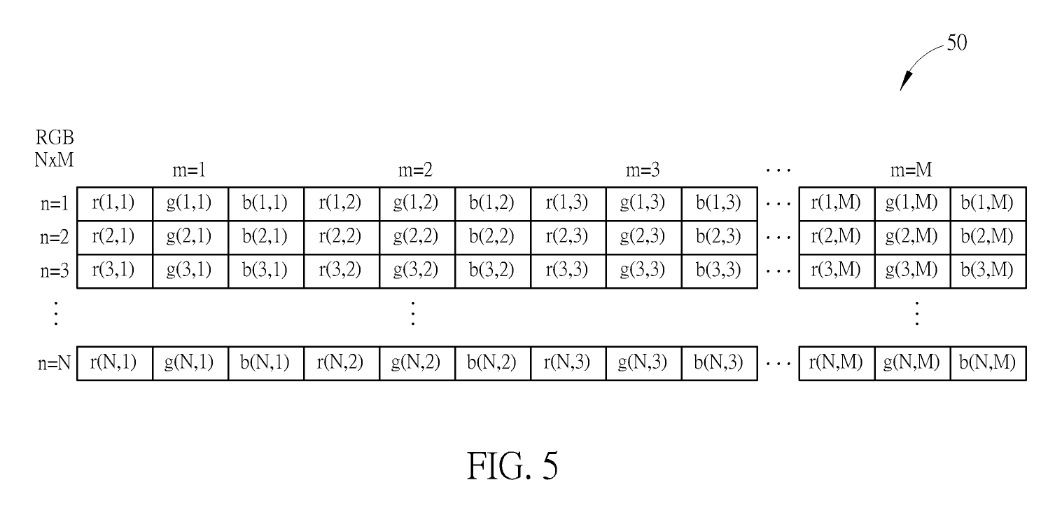

More details of subpixel rendering operation are described as follows. The subpixel rendering unit 210 implements the subpixel rendering (SPR) technology, which renders pixel data based on the physical subpixel arrangement of the display panel 112 to increase the visual display resolution. For example, FIG. 3 is a schematic diagram of pixels of a full-color (or called true-color) display panel of RGB stripe type. Each pixel (e.g., a pixel p_11) includes three subpixels (e.g., the red subpixel r_11, the green subpixel g_11 and the blue subpixel b_11). However, subpixels of the display panel 112 in FIG. 1 or FIG. 2 may be arranged in different patterns or subpixel geometry. FIG. 4 is a schematic diagram of pixels of the display panel 112 of an exemplary subpixel arrangement according to an example of the present disclosure. The display panel 112 includes a pixel P_11 consisting of a red subpixel R_11 and a green subpixel G_11, a pixel P_12 consisting of a blue subpixel B_12 and a green subpixel G_12, a pixel P_21 consisting of a blue subpixel B_21 and a green subpixel G_21, and a pixel P_22 consisting of a red subpixel R_22 and a green subpixel G_22. The gray level, or the luminance, of each subpixel is determined based on the image data D5b from the image processing unit 20. The display panel 112 of FIG. 4 illustrates an exemplary layout for an LCD panel, wherein red and blue subpixels have a larger aperture ratio than green subpixels, compensating for the number of red or blue subpixels which is less than the number of green subpixels. It should be noted that the display panel which receives the image data generated according to the embodiment of the present invention is not limited to an LCD panel or an OLED panel.

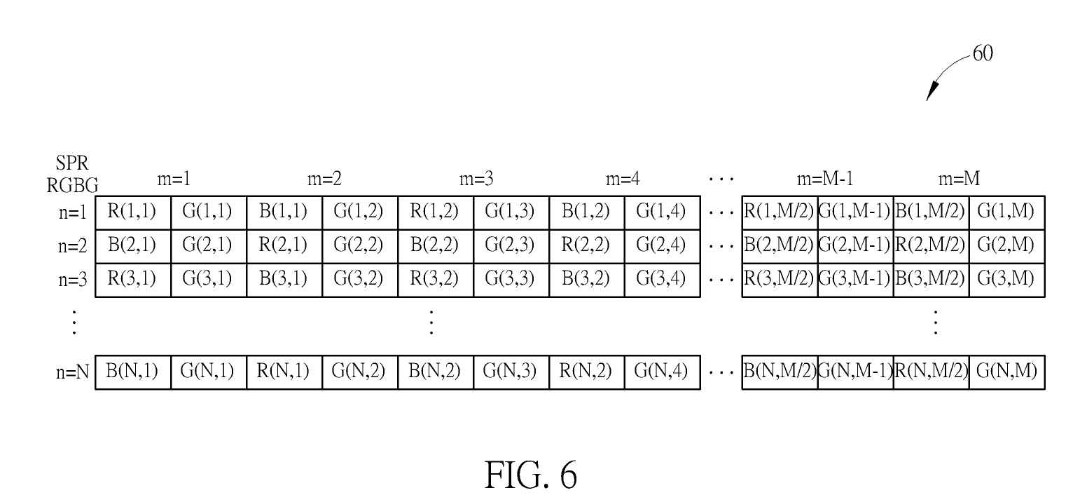

FIG. 5 is a schematic diagram of image data of a frame 50 as the image data D2b received by the subpixel rendering unit 210. FIG. 6 is a schematic diagram of image data of a frame 60 as the image data D3b generated by the subpixel rendering unit 210 and configured to be displayed on a display panel having N×M pixels with RGBG subpixel arrangement as shown in FIG. 4. It can be seen that the resolution of red and blue subpixels of the frame 60 is a half of the resolution of red and blue subpixels of the frame 50. In FIG. 5 and FIG. 6, r (n,m), g (n,m), b (n,m), R (n,m), G (n,m) and B (n,m) indicate each subpixel data, and R(n,m), G(n,m) and B(n,m) is not equivalent to r(n,m), g(n,m) and b(n,m). The subpixel rendering unit 210 generates, for example, subpixel data R(n,m) of the frame 60 based on subpixel data r(n,m) of the frame 50 and it neighbor subpixel data r(n,m−1) and r(n, m+1).

The reduced size of the image data D3b facilitates the execution of the compression encoder 202 of the image processing unit 20 because the size of the image data D3b transmitted into the compression encoder 202 is ⅔×K bits instead of K bits of the image data D1b.

After the image data D3b is received, the compression encoder 202 performs an encoding process, and the encoding process for the compression encoder 202 may follow the industrial standards such as Display Stream Compression (DSC) by VESA, Frame Buffer Compression (FBC) by Qualcomm, or any other feasible data compression scheme. In an embodiment, the compression encoder 202 may be referred to a DSC encoder, but is not limited herein.

The compression decoder 206 performs a decoding process, which is the inverse version of the encoding process of the compression encoder 202. The compression decoder 206 may follow the industrial standards such as DSC by VESA, FBC by Qualcomm, or any other feasible data decompression scheme.

In the conventional image processing unit 10 of FIG. 1, if based on a refresh rate 60 Hz (i.e., 60 frames per second), the compression decoder 106 has to read the image data D2a from the frame buffer 104 every 1/60 seconds, regardless of how many frames are being fed to the frame buffer 104 by the compression encoder 102 per second. However, the image input unit 100 may feed the image data D1a into the image processing unit 10 in a frame rate less than the refresh rate 60 Hz, such as 30 Hz. In such a condition, in order to meet the refresh rate 60 Hz, the compression decoder 106 has to repeatedly read the same frame (as image data D2a) twice from the frame buffer 104 and perform the decoding process twice, the image enhancement unit 108 has to perform image enhancement on the same frame (as image data D3a) twice, and the subpixel rendering unit 110 has to perform subpixel rendering operation on the same frame (as image data D4a) twice, which wastes lots of power.

Under a similar condition that the refresh rate is 60 Hz but the frame rate is 30 Hz, regarding to the image processing unit 20 of FIG. 2 (or in view of a process of FIG. 2), the image enhancement unit 208, the subpixel rendering unit 210 and the compression encoder 202 run according to the frame rate 30 Hz instead of the refresh rate 60 Hz and not necessary to perform operations on the same frame twice. Only the compression decoder 206 has to read the same frame (as image data D4b) twice from the frame buffer 204 and performs the decoding process twice to meet the refresh rate 60 Hz. Compared to the power consumption of the image processing unit 10, the image processing unit 20 can reduce power consumption significantly when the image processing unit 20 receives image data from the image input unit in a frame rate lower than the refresh rate.

Besides, in the image processing unit 10, the image enhancement unit 108 performs image enhancement on the image data D3a which may have distortion since the image data D3a is generated through the encoding and decoding processes (by the compression encoder 102 and the compression decoder 106). If the image data D3a is generated after heavy compression (and decompression), the image data D3a may have severe blur and lose many details. In such a condition, the image data D4a generated by the image enhancement unit 108 may not have a good picture quality. In comparison, in the image processing unit 20, the image enhancement unit 208 performs image enhancement on the image data D1b which is not yet processed through the encoding process and the decoding process, instead of performing image enhancement on the reconstructed image data generated by the compression decoder 206. Therefore, the image enhancement unit 208 generates the image data D2b which preserves more details than the image data D4a generated by the image enhancement unit 108. As a result, the image data D5b outputted by the image processing unit 20 can achieve higher quality than the image data D5a outputted by the image processing unit 10.

Please note that the image processing unit 20 is an exemplary embodiment of the invention, and those skilled in the art may make alternations and modifications accordingly. For example, the compression ratio of the compression encoder 102 shown in FIG. 1 and the compression ratio of the compression encoder 202 shown in FIG. 2 are set to 3:1. Consequently, the compression encoder 102 resizes the image data D1a of K bits to ⅓×K bits; the compression encoder 202 resizes the image data D3b of ⅔×K bits to 2/9×K bits. The present invention is not limited thereto, however.

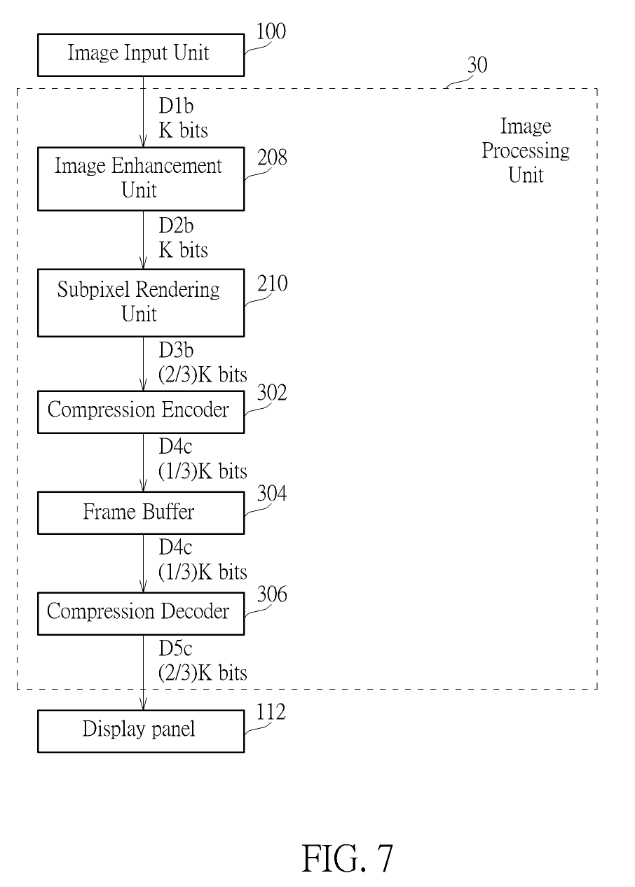

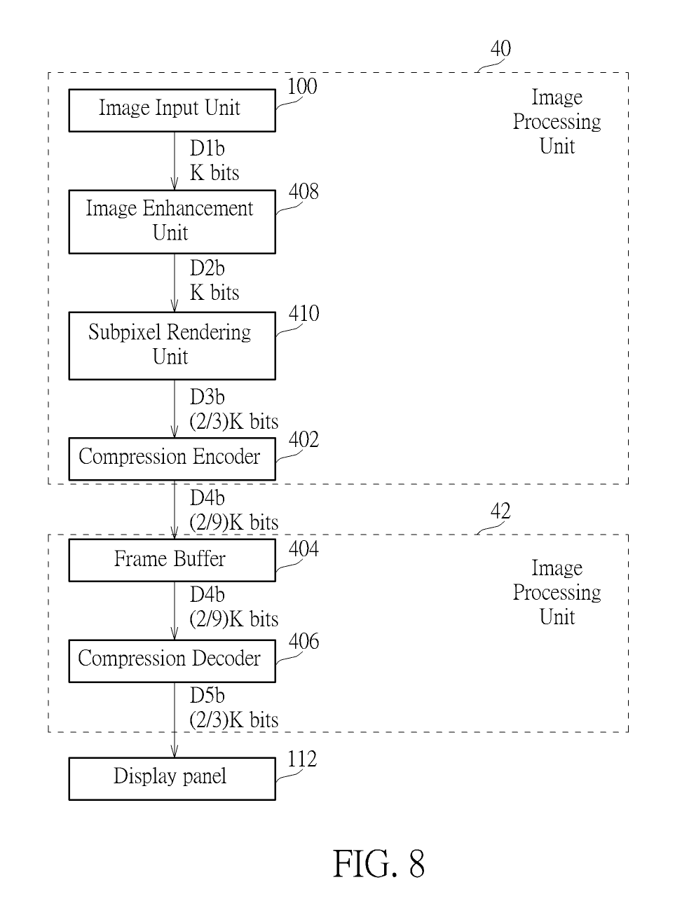

For example, please refer to FIG. 7, which is a schematic diagram of an image processing unit 30 according to an embodiment of the present invention. The structure of the image processing unit 30 is similar to that of the image processing unit 20 shown in FIG. 2 so that the same numerals and symbols denote the same components in the following descriptions. Unlike the compression encoder 202 of the image processing unit 20, a compression encoder 302 of the image processing unit 30 has a compression ratio 2:1; that is to say the compression encoder 302 may encode the image data D3b of ⅔×K bits to be image data D4c of ⅓×K bits. In such a situation, the image processing unit 30 can have the frame buffer 304 of a size accommodating at least ⅓×K bits. The image processing unit 30 is installed in an image processing apparatus. The image processing apparatus where the image processing unit 30 is installed may be a display driver IC used in a mobile device or a handheld device (such as mobile phone, tablet, camera, etc.) or a timing controller used in a TV or a monitor.

In an exemplary embodiment, an image processing apparatus which uses the image processing unit according to the embodiments of the present invention is expected to support multiple image processing paths including the conventional process as shown in FIG. 1 (wherein data compression ratio 3:1 is used) and the process as shown in FIG. 7 (wherein data compression ratio 2:1 is used), and a frame buffer of a size at least ⅓×K bits is shared for either storing image data generated by the compression encoder 102 or storing image data generated by the compression encoder 302. In another exemplary embodiment, an image processing apparatus is expected to support multiple image processing paths including the conventional process as shown in FIG. 1 and the process as shown in FIG. 2, and a frame buffer of a size at least ⅓×K bits is shared for either storing image data generated by the compression encoder 102 or storing image data generated by the compression encoder 202, since the frame buffer of a size ⅓×K bits is enough for storing the image data D4b ( 2/9×K bits).

The frame buffers 204 and 304 may be selected from a random-access memory (RAM), a static RAM (SRAM), a dynamic RAM (DRAM), a video RAM (VRAM), a flash memory, etc. The display panel 112 may be a liquid crystal display (LCD) panel or organic light emitting diode (OLED) display panel.

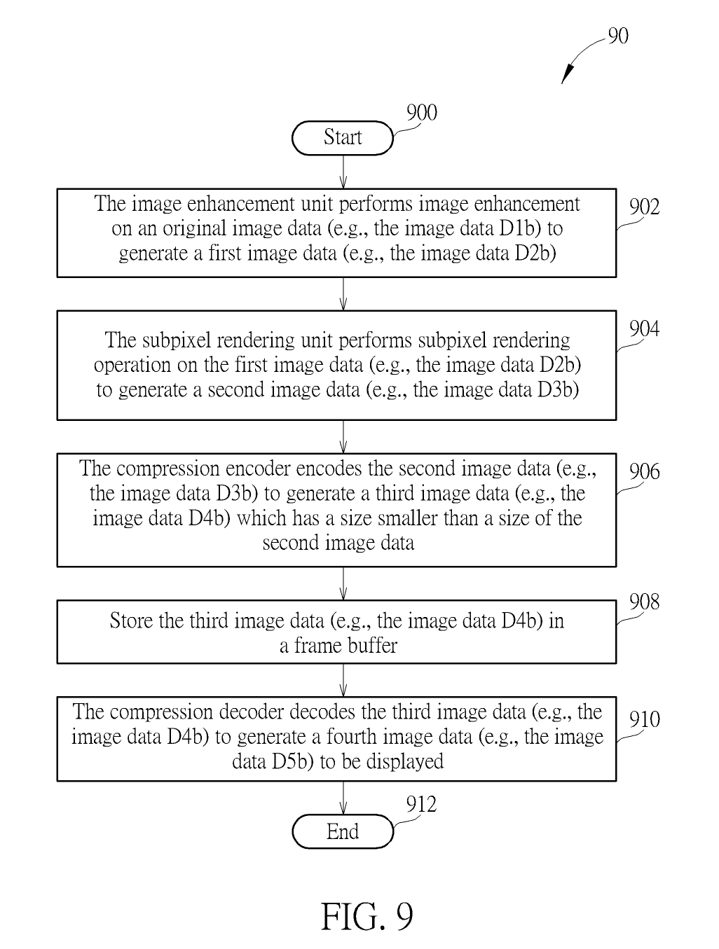

Please refer to FIG. 8, which is a schematic diagram of an image processing unit 40 according to an embodiment of the present invention. The same numerals as FIG. 2 are used to denote the image data shown in FIG. 8 and in the following descriptions. In addition to the image processing unit 40, another image processing unit 42 is also illustrated in FIG. 8. The image processing unit 40 includes an image enhancement unit 408, a subpixel rendering unit 410, and a compression encoder 402. The image processing unit 42 comprises a frame buffer 404 and a compression decoder 406. The image processing unit 42 is coupled to the image processing unit 40 and image data (D4b) generated by the compression encoder 402 is transmitted to the image processing unit 42 and stored in the frame buffer 404. Though the units (402 to 410) may be implemented in different image processing apparatuses, each respective unit may have similar functionality as the units shown in FIG. 2 and are not repeatedly narrated herein.

The image processing unit 40 and the image processing unit 42 may be respectively installed in different image processing apparatuses. In an example, the image processing unit 40 may be installed in an application processor of a mobile device and the image processing unit 42 may be installed in a display driver IC (for small or medium-scale display panel) of the mobile device. In another example, the image processing unit 40 may be installed in a TV controller or a graphic controller and the image processing unit 42 may be installed in a timing controller (for large-scale display panel). In cooperation with the image processing apparatus using the image processing unit 40, the image processing apparatus using the image processing unit 42 can have reduced image processing tasks since image enhancement, subpixel rendering operation and compression encoding are handled by the image processing apparatus using the image processing unit 40.

The abovementioned image processing operations of the image processing unit may be summarized into an image processing process 90, as shown in FIG. 9. The image processing process 90, which may be performed in the image processing unit 20 or 30, or may be performed under the cooperation of the image processing units 40 and 42, includes the following steps:

Step 900: Start.

Step 902: The image enhancement unit performs image enhancement on an original image data (e.g., the image data D1b) to generate a first image data (e.g., the image data D2b).

Step 904: The subpixel rendering unit performs subpixel rendering operation on the first image data (e.g., the image data D2b) to generate a second image data (e.g., the image data D3b).

Step 906: The compression encoder encodes the second image data (e.g., the image data D3b) to generate a third image data (e.g., the image data D4b) which has a size smaller than a size of the second image data.

Step 908: Store the third image data (e.g., the image data D4b) in a frame buffer.

Step 910: The compression decoder decodes the third image data (e.g., the image data D4b) to generate a fourth image data (e.g., the image data D5b) to be displayed.

Step 912: End.

The detailed operations and alternations of the image processing process 90 are illustrated in the above descriptions, and will not be narrated herein.

To sum up, in the image processing unit according to embodiments of the present invention, the image enhancement and subpixel rendering operation are performed before the compression encoding/decoding and buffering storage operations. Therefore, the subpixel rendering unit efficiently reduces the size of image data to be stored in the frame buffer. As a result, the frame buffer size may be reduced by performing subpixel rendering operation earlier than the encoding process, and the physical size and cost of the apparatus using the image processing unit or the image processing method according to embodiments of the present invention may be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method comprising:
performing subpixel rendering operation on a first image data to generate a second image data; and
encoding the second image data to generate a third image data which has a size smaller than a size of the second image data.

2. The image processing method of claim 1, further comprising:
storing the third image data in a frame buffer; and
decoding the third image data to generate a fourth image data to be displayed.

3. The image processing method of claim 2, wherein performing subpixel rendering operation on the first image data, encoding the second image data, storing the third image data, and decoding the third image data are operated in an image processing apparatus.

4. The image processing method of claim 3, further comprising:
performing, in the image processing apparatus, image enhancement on an original image data to generate the first image data.

5. The image processing method of claim 3, wherein the image processing apparatus is a display driver IC or a timing controller.

6. The image processing method of claim 2, wherein performing subpixel rendering operation on the first image data and encoding the second image data are operated in a first image processing apparatus, and storing the third image data and decoding the third image data are operated in a second image processing apparatus.

7. The image processing method of claim 6, further comprising:
performing, in the first image processing apparatus, image enhancement on an original image data to generate the first image data.

8. The image processing method of claim 6, wherein the first image processing apparatus is a processor, and the second image processing apparatus is a display driver IC or a timing controller.

9. The image processing method of claim 1, wherein performing subpixel rendering operation on the first image data and encoding the second image data are operated in a processor.

10. An image processing apparatus, configured to render image displayed on a display, the image processing apparatus comprising:
a subpixel rendering unit, configured to perform subpixel rendering operation on a first image data to generate a second image data; and
a compression encoder, configured to encode the second image data to generate a third image data which has a size smaller than a size of the second image data.

11. The image processing apparatus of claim 10, further comprising:
a frame buffer, configured to store the third image data; and
a compression decoder, configured to decode the third image data to generate a fourth image data to be displayed.

12. The image processing apparatus of claim 10, further comprising:
an image enhancement unit, configured to perform image enhancement on an original image data to generate the first image data.

13. The image processing apparatus of claim 11, wherein the image processing apparatus is a display driver IC or a timing controller.

14. The image processing apparatus of claim 10, wherein the image processing apparatus is a processor.

15. The image processing apparatus of claim 14, further comprising:
an image enhancement unit, configured to perform image enhancement on an original image data to generate the first image data.
